(19) United States
(12) Patent Application Publication
(10) Pub. No.: US 2011/0266889 A1
(43) Pub. Date: Nov. 3, 2011

(54) COST EFFECTIVE ENERGY SAVING DEVICE

(75) Inventor: MARY LOUISE BLOHM, Ellijay, GA (US)

(73) Assignee: COVE DISTRIBUTION, INC., Coral Springs, FL (US)

(21) Appl. No.: 12/770,329

(22) Filed: Apr. 29, 2010

(51) Int. Cl. H02J 3/00

(52) U.S. Cl. 307/117

(57) ABSTRACT

This descriptive document is about a new low cost electrical power saving device that fulfills this objective detecting signals emitted by standard remote control units of electric appliances plugged to the device.

Under one aspect, the device includes a male plug extending from a small, unitary housing that plugs into a wall outlet, a female receptacle disposed in the housing that accepts a power cord of an appliance, a timer and an infrared sensor on an outer surface of the housing that detects infrared pulses and generates a reset signal in response thereto, wherein, the timer has a reset state where the timer electrically connects power from the male plug to the female receptacle and a timed-out state where the timer disconnects power to the female receptacle, the timer enters the timed-out state a predetermined time period after receipt of a most recent reset signal from the infrared sensor and where the timer enters the reset state each time the timer receives a reset signal.

### FIELD OF INVENTION

The field of the invention relates to energy saving devices and more particularly to household energy protection/management devices.

### CROSS REFERENCE

To be completed

### BACKGROUND OF THE INVENTION

Many modern appliances, especially large TV sets consume large amounts of AC power, even when they are turned off. Often they are left on unattended causing unneeded energy consumption, wear and heat generation. The Energy Saver Device of the invention described below is an intuitive and low cost solution to these drawbacks.

### SUMMARY OF THE INVENTION

The Energy Saving Device described below takes advantage of any signal emitted by an appliance infrared remote control. In presence of such signal, AC current keeps flowing to appliances during a reset state involving a preset ON timing cycle. In absence of such signal, the ON cycle time will come close to completion, and the user will be warned by the device (visual and/or aural signal) of such event. If the user does not operate the remote control at least once within a preset time warning cycle, the device will automatically enter a timed out state and turn off the appliance by suppressing AC current.

In one aspect, the device is plugged between an electrical home appliance and the AC power grid. The device includes an electronic switch wired in such way that the AC power to a plug in receptacles can be activated on upon reception of a command signal (switch ON), or turned off after a preset time in absence of a command signal (switch OFF), a remote receiver capable of detecting signals emitting from conventional infrared (IR) remote controls, wherein each time the receiver detects a signal from a remote control within range, it will send a command signal to the electronic switch to a controlling circuit which performs functions of: timing and signaling processing. The device also includes a remote indicator coupled to the controlling circuit and designed to signal when the timer “On Cycle” is about to end, so that a remote control can be manipulated and thus send a signal to the remote receiver to reset the timer and to allow AC power to keep flowing to the appliance connected to the receptacles of the electronic switch.

### BRIEF DESCRIPTION OF DRAWINGS

FIG. 1 depicts an energy saving device diagram show in accordance with an illustrated embodiment of the invention;

FIGS. 2A-C depict an activation sequence of the device of FIG. 1; and

FIGS. 3A-D depict an energy saving sequence provided by the device of FIG. 1.

### DESCRIPTION OF AN EMBODIMENT OF THE INVENTION

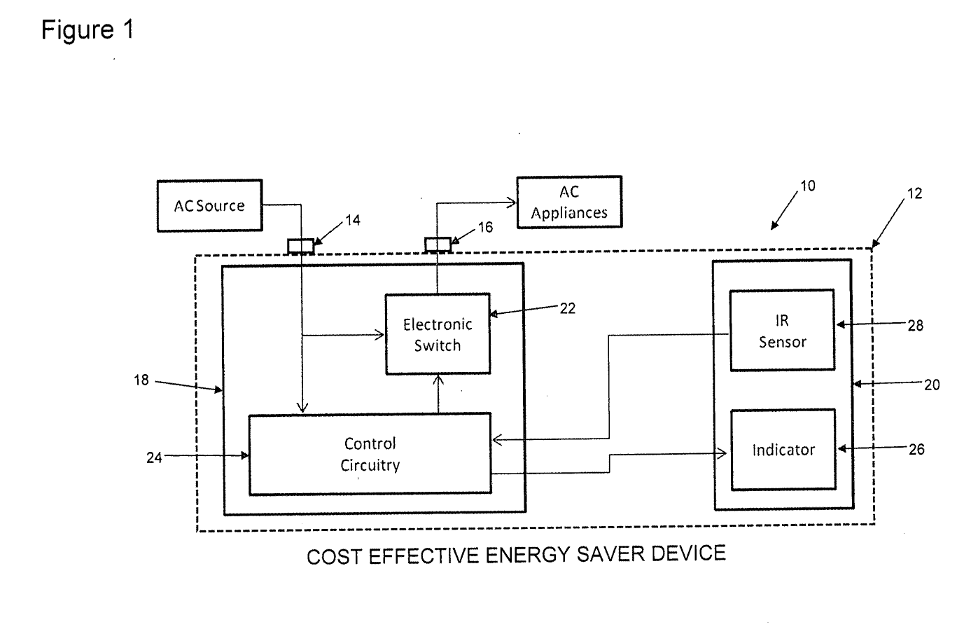

FIG. 1 is a schematic diagram of an energy saving device 10 shown generally in accordance with illustrated embodiments of the invention. The device 10 is comprised of: a main module 18 (to the left) and an auxiliary remote module 20 (to the right). The main module 18 contains an electronic ON/OFF switch 22 and a control and timer circuit 24 which commands all device functions.

The control circuitry 24 may be implemented as a microprocessor including one or more programs on a computer readable medium. The computer programs, together or individually, may implement one or more timing functions.

The auxiliary remote module 20 contains an infrared (IR) sensor 28 capable of detecting any signal emitted by an appliance remote control. It also contains a visual/aural indicator 26. Both the main and auxiliary modules 18, 20 interact. The IR sensor 28 is coupled to the control circuit 24 and the visual/aural indicator 26 is commanded by the control circuit 24.

AC energy source is connected to the control circuit 24 and electronic switch 22 of the main module 18. The output of the electronic switch 22 is wired to the appliance, so that AC current flows selectively depending of the device status.

The cost effective energy saving device 10 may be incorporated into a small box or housing 12 with a male plug 14 that plugs directly into any wall outlet. Versions would be available for any outlet topology/voltage/frequency configuration. Also on the same box there are one or more female receptacles 16 into which the appliance is plugged. The topology of the box could be similar to the one of a terminal strip.

Inside the box 12 (FIG. 1) is the electronic switch 22 wired in such way that the power to the receptacle(s) 16 can be activated upon reception of a command signal sent by the control circuit 24. Once this command signal is received, the control circuit 24 enters an ON state where AC power will flow into the receptacles 16 for a preset time period (ON Time). If no further command or reset signals are received during such ON period, the controller 24 will enter the OFF state and the power to the receptacle(s) 16 will be turned off by the electronic switch 22 immediately after the ON period ends. If a command signal is received during the ON Time, the preset time period will reset and a new cycle will begin. If the command is received while the switch is in its OFF state, it will turn on and begin a new On Time cycle.

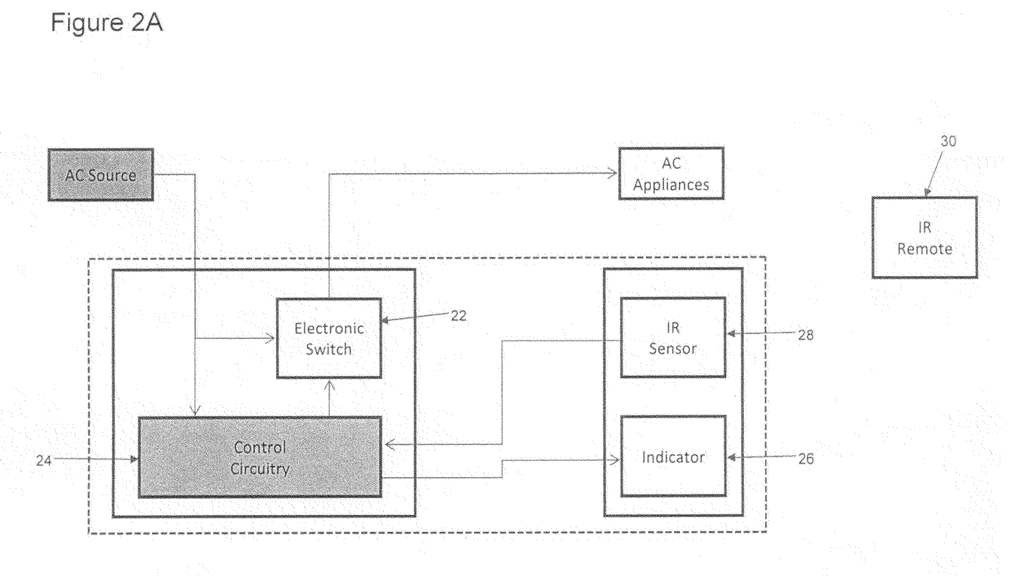

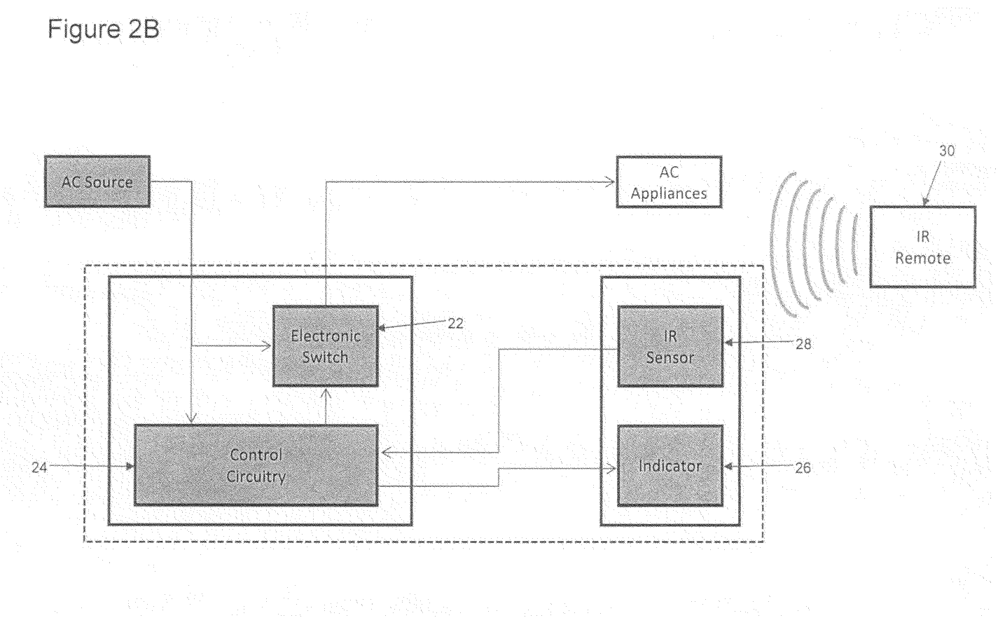

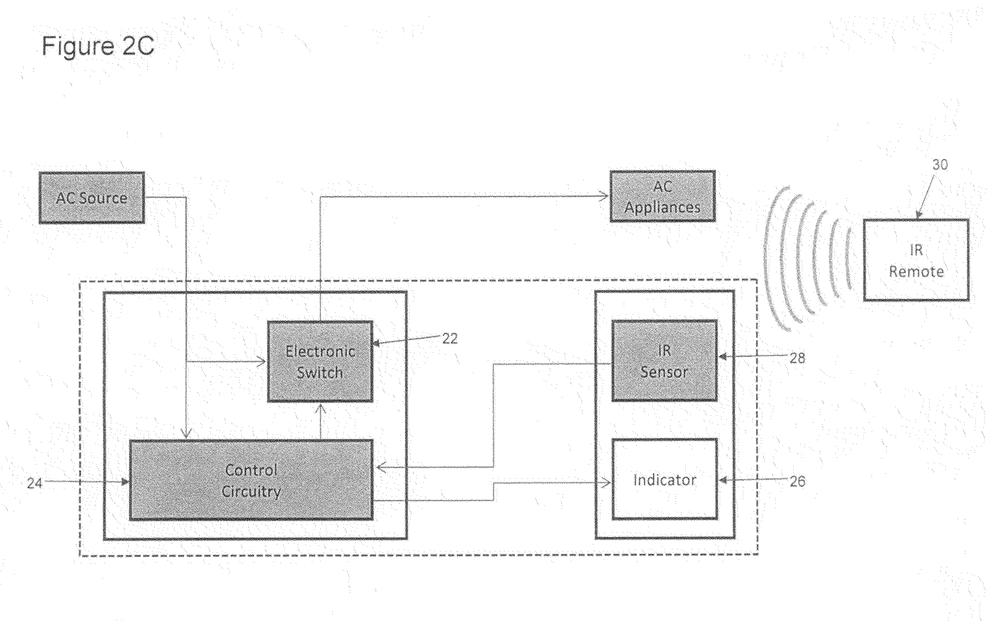

FIGS. 2A to 2C show the Energy Saving device and appliance turn ON (activation) sequence (First time). FIG. 2A illustrates an initial state, where both the appliance and the device are deactivated.

The IR Sensor 28 of the Energy Saving Device 10 is of a technology such that it can detect signals emitting from conventional remote controls of various technologies, most commonly but not limited to, infrared. Each time this IR sensor 28 detects a signal from a remote control 30 within range, it will send a command or reset signal to the control circuit (FIG. 2B and 2C) 24. In this sequence, the first IR signal from the remote control is used to activate a first control and timing program of the control circuit 24 and to energize all components of the Energy Saving Device 10 and close the Electronic Switch 22. The visual/audible indicator will activate to indicate the user that an IR signal was detected, thus causing AC power to flow to the appliance (FIG. 2B), and the second IR signal will be received and processed by the energized appliance. This will normally be a “turn on” command (FIG. 2C).

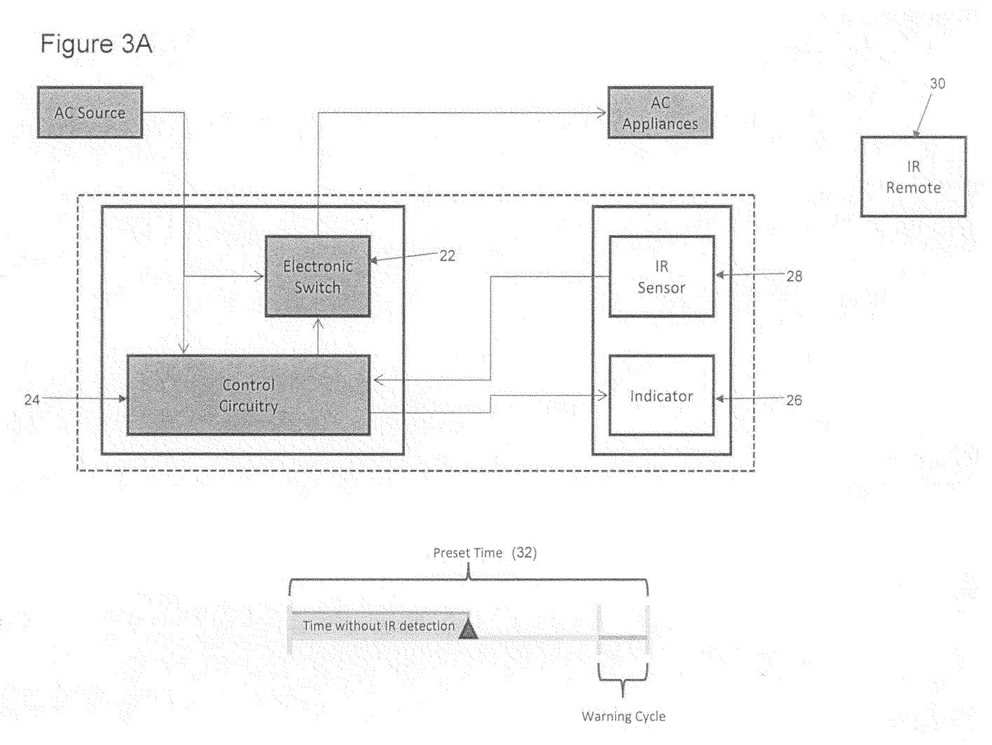

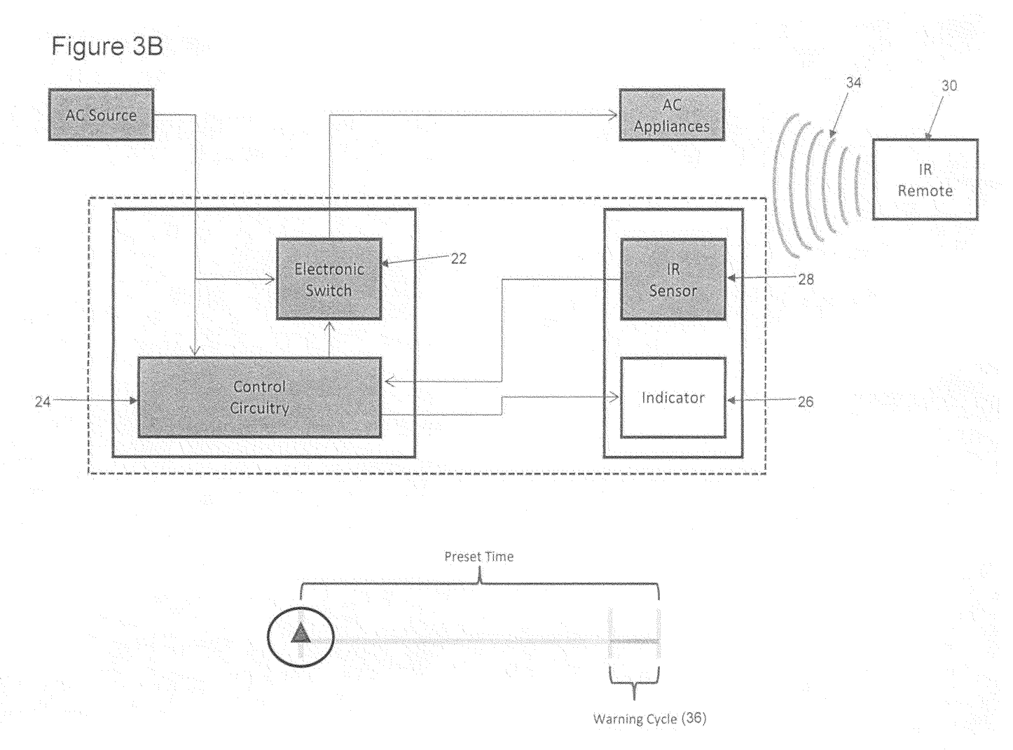

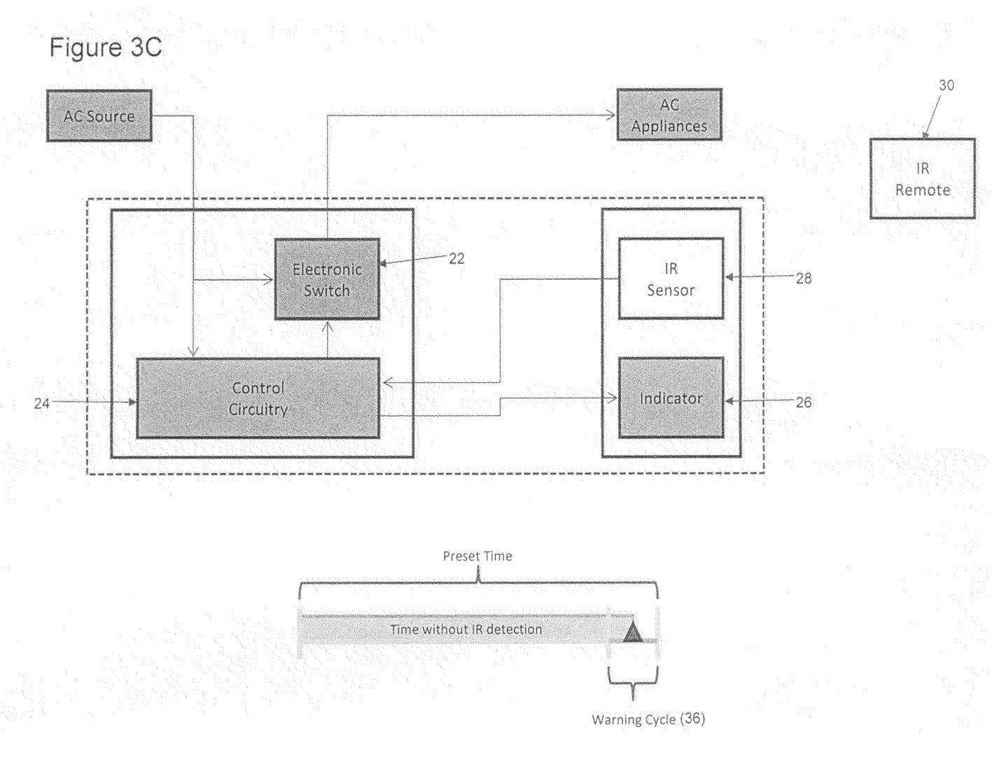

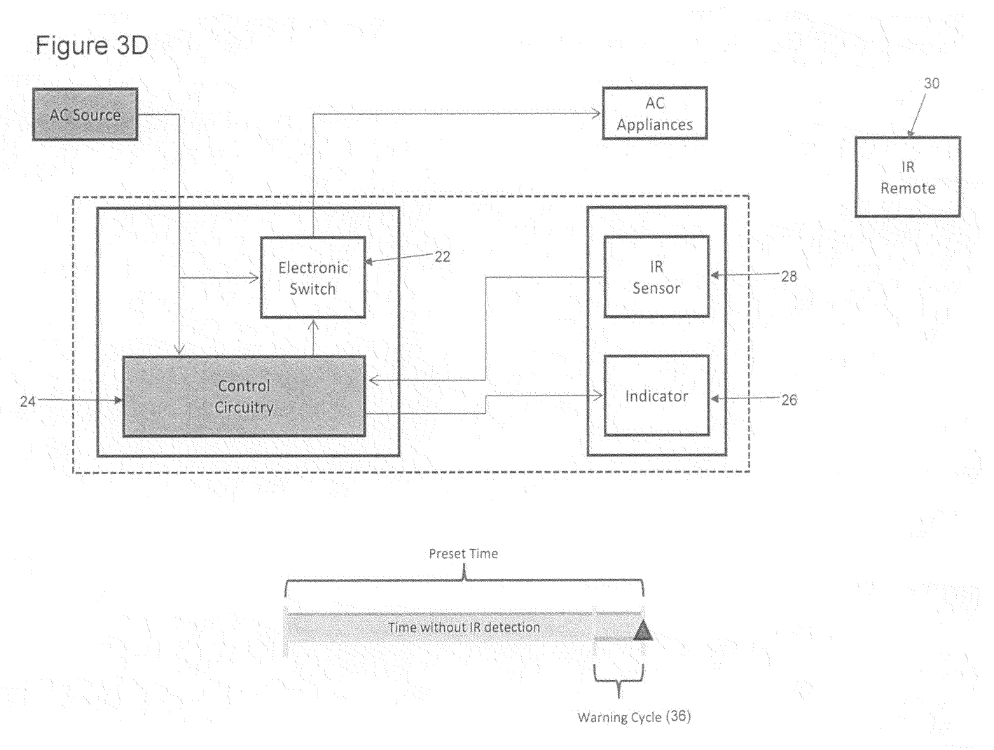

FIGS. 3A to 3D show the saving energy function sequence of the device 10. Once all circuits are energized in the ON state, a preset time period 32 (controlled by the first timing control program) begins to lapse (ON Time), as shown in the time line at the bottom of FIG. 3A. In the absence of any IR signal 34 from the remote control 30, all circuits will stay energized and the appliance functioning (FIG. 3A). If the IR sensor 28 detects a new IR signal 34 from the remote control during the ON Time period, it will immediately send a signal to the control circuit and this will reset the preset time period of the first timing control program to zero (as shown in the time line at the bottom of FIG. 3B, where the circled arrow indicates that the timer has been reset or reinitialized). As a consequence, a new ON Time period will begin and all circuits will stay energized.

If, on the contrary, time lapses and there is not a IR signal received from the remote control, the preset time period will enter into a warning phase 36 or warning cycle of the time interval (shown in the time line at the bottom of FIG. 3C). This may be indicated or controlled by a second time (warning control) program within the controller 24. During such cycle, the warning control program of the control circuit 24 will send a visual and/or aural warning sign to the user through an indicator 26 embedded in an outer surface of the device 10.

Finally, if the warning cycle of the preset time periods ends in absence of an IR signal detected by the IR sensor 28 of the device 10, the control circuit 24 will command the electronic switch to toggle to an OFF position (state), and AC current flow to the appliance will cease. (FIG. 3D). Alternatively, the first timing control program toggles to the off state and simply deactivates a signal to the switch 22.

The interaction between signals emitted by any standard infrared remote control and the above described device 10 provides an automatic appliance turn off function (i.e., a cost effective energy saving function) that reduces wasted energy. Many devices can benefit from the device 10. For example, television sets, stereophonic equipment, electronic surge protectors, electronic voltage protectors, and electronic voltage regulators may be equipped with the above device 10 to achieve energy saving functionality.

To the best of the inventor's knowledge, all existing commercial energy saving devices require an AC current detection circuit or a movement detector, thus incorporating an element of extra cost and complexity.

A specific embodiment of method and apparatus for saving energy has been described for the purpose of illustrating the manner in which the invention is made and used. It should be understood that the implementation of other variations and modifications of the invention and its various aspects will be apparent to one skilled in the art, and that the invention is not limited by the specific embodiments described. Therefore, it is contemplated to cover the present invention and any and all modifications, variations, or equivalents that fall within the true spirit and scope of the basic underlying principles disclosed and claimed herein.

1. A device plugged between an electrical home appliance and the AC power grid, comprising of:
(1) electronic switch wired in such way that the AC power to a plug in receptacles can be activated on upon reception of a command signal (switch ON), or turned off after a preset time in absence of a command signal (switch OFF);
(2) a remote receiver capable of detecting signals emitting from conventional infrared (IR) remote controls, wherein each time the receiver detects a signal from a remote control within range, it will send a command signal to the electronic switch through a controlling circuit;
(3) the controlling circuit which performs functions of: timing and signaling processing; and
(4) a remote indicator coupled to the controlling circuit and designed to signal when the timer “On Cycle” is about to end, so that a remote control can be manipulated and thus send a signal to the remote receiver to reset the timer and to allow AC power to keep flowing to the appliance connected to the receptacles of the electronic switch.

2. The device as in claim 1 wherein the remote indicator further comprises a visual indicator.

3. The device as in claim 1 wherein the remote indicator further comprises an audible indicator.

4. A device comprising:
a housing;
a male plug extending from the housing that plugs into a wall outlet;
a female receptacle disposed in the housing that accepts a power cord of an appliance, the appliance operating under control of a remote infrared controller;
a switch within the housing that electrically connects power from the male plug to the female receptacle;
a timer coupled to the switch, the timer having a reset state where the timer causes the switch to electrically connects power from the male plug to the female receptacle and a timed-out state that the timer enters after expiration of a predetermined time first following receipt of a reset signal where in the timed-out state the timer disconnects electrically power from the male plug to the female receptacle and where the timer enters the reset state each time the timer receives a reset signal; and
an infrared receiver that detects infrared signals and that resets the timer each time an infrared signal is detected.

5. The device as in claim 4 further comprising an annunciator that warns a user that the predetermined time period is about to expire.

6. The device as in claim 4 wherein the annunciator further comprises a warning light.

7. The device as in claim 4 wherein the annunciator further comprises an audible device.

8. The device as in claim 4 wherein the timer further comprises an adjustable timer.

9. A device comprising:
a male plug extending from a small, unitary housing that plugs into a wall outlet;
a female receptacle disposed in the housing that accepts a power cord of an appliance;
a timer; and
an infrared sensor on an outer surface of the housing that detects infrared pulses and generates a reset signal in response thereto, wherein, the timer has a reset state where the timer electrically connects power from the male plug to the female receptacle and a timed-out state where the timer disconnects power to the female receptacle, the timer enters the timed-out state a predetermined time period after receipt of a most recent reset signal from the infrared sensor and where the timer enters the reset state each time the timer receives a reset signal.

10. The device as in claim 9 further comprising a plurality of female receptacles.
